(19) United States
(12) Patent Application Publication
(10) Pub. No.: US 2025/0159659 A1
(43) Pub. Date: May 15, 2025

(54) WIRELESS COMMUNICATION SYSTEM, TERMINAL, AND COMMUNICATION METHOD

(71) Applicant: NIPPON TELEGRAPH AND TELEPHONE CORPORATION, Tokyo (JP)

(72) Inventors: Daisuke MURAYAMA, Tokyo (JP); Toshiro NAKAHIRA, Tokyo (JP)

(21) Appl. No.: 18/708,304

(22) PCT Filed: Dec. 17, 2021
(86) PCT No.: PCT/JP2021/046859

§ 371 Date: May 8, 2024

(51) Int. Cl. H04W 72/04; H04W 74/0808

(52) U.S. Cl. CPC H04W 72/04; H04W 74/0808

(57) ABSTRACT

Provided is a wireless communication system provided with a base station and a plurality of terminals and operated by a licensed band, wherein the base station allocates, to the plurality of terminals, a radio resource for transmission that allows overlapping between the plurality of terminals, and all or some of the plurality of terminals execute listen before talk (LBT) and then perform transmission using the allocated radio resource.

### TECHNICAL FIELD

The present invention relates to a wireless communication system that performs operations in a licensed band.

### BACKGROUND ART

In a wireless communication system such as New Radio (NR) or Long Term Evolution (LTE) defined by the 3rd Generation Partnership Project (3GPP), a terminal and a base station can perform communication in a licensed band, which is a frequency band granted to an operator, and communication in an unlicensed band, which is a frequency band other than the licensed band.

In a licensed band, a system side allocates exclusive (non-overlapping) radio resources to a plurality of terminals to perform communication, thereby preventing channel contention and data collision among the plurality of terminals. In addition, in an unlicensed band, listen before talk (LBT) is implemented after an idle state is confirmed by performing channel sensing before transmission.

### CITATION LIST

### Non Patent Literature

NPL 1: 3GPP TS38.214 (g70) 6.1.2

### SUMMARY OF INVENTION

### Technical Problem

In a communication system using a licensed band in known art, exclusive radio resources are allocated to a plurality of terminals in order to avoid data collision. However, in a case in which exclusive radio resources are allocated to each terminal and the allocated terminals cannot use up the allocated radio resources, resource utilization efficiency decreases.

The present invention has been made in view of the above points, and an object thereof is to provide a technique for improving resource utilization efficiency while avoiding collisions in a licensed band.

### Solution to Problem

According to the disclosed technique, a wireless communication system provided with a base station and a plurality of terminals and operated by a licensed band, wherein the base station allocates, to the plurality of terminals, a radio resource for transmission that allows overlapping between the plurality of terminals, and all or some of the plurality of terminals execute listen before talk (LBT) and then perform transmission using the allocated radio resource, is provided.

### Advantageous Effects of Invention

According to the disclosed technique, it is possible to provide a technique for improving resource utilization efficiency while avoiding collision in a licensed band.

### BRIEF DESCRIPTION OF DRAWINGS

FIG. 1 is a diagram for explaining a problem according to a first embodiment.

FIG. 2 is a diagram for explaining a processing operation of the first embodiment.

FIG. 3 is a diagram for explaining a processing operation of the first embodiment.

FIG. 4 is a diagram showing a system configuration example according to the first embodiment.

FIG. 5 is a flowchart for explaining operations according to the first embodiment.

FIG. 6 is a diagram for explaining a problem according to a second embodiment.

FIG. 7 is a diagram for explaining a problem according to the second embodiment.

FIG. 8 is a diagram for explaining a processing operation of the second embodiment.

FIG. 9 is a diagram showing a system configuration example according to the second embodiment.

FIG. 10 is a flowchart for explaining operations according to the second embodiment.

FIG. 11 is a flowchart for explaining operations according to the second embodiment.

FIG. 12 is a flowchart for explaining operations according to the second embodiment.

FIG. 13 is a diagram showing an example of a functional configuration of a terminal.

FIG. 14 is a diagram showing an example of a functional configuration of a base station,

FIG. 15 is a diagram showing an example of a hardware configuration of a device.

### DESCRIPTION OF EMBODIMENTS

Embodiments of the present invention (present embodiment) will be described below with reference to the drawings. The embodiments described below are merely exemplary, and embodiments to which the present invention is applied are not limited to the following embodiments.

A first embodiment and a second embodiment will be described below as the embodiments of the present invention. The first embodiment is an embodiment in which the present invention is applied to uplink communication, and the second embodiment is an embodiment in which the present invention is applied to inter-terminal communication. The first embodiment and the second embodiment can be implemented in combination.

A wireless communication system in each embodiment is mainly assumed to be an NR system (or an LTE system) defined by 3GPP, but is not limited to thereto. For example, the technique according to the present invention can also be applied to 3G and 6G.

### First Embodiment

In the first embodiment, a base station grants utilization of a non-exclusive (that is, commonly overlapping) radio resource to a plurality of terminals for uplink communication by pre-grant of transmission using a licensed band in a wireless communication system, thereby improving resource utilization efficiency. Since each terminal is granted use of the non-exclusive radio resource, each terminal executes an LBT operation at the time of uplink signal transmission.

In addition, in the first embodiment, the method of pre-grant of transmission (configured grant) is used as an example, but the technique according to the present invention can be applied to methods other than this method. For example, the technique according to the present invention can also be applied to semi-persistent scheduling or dynamic scheduling. However, in dynamic scheduling, in many cases, radio resources are allocated on the basis of an amount of transmission requests, and a state in which the allocated radio resource cannot be used up is not considered to occur frequently. For this reason, opportunities for application to dynamic scheduling and expectable effects are considered to be relatively fewer than others. The content of the first embodiment will be described in more detail below.

### Problems

In a 5G New Radio (NR), which is assumed to be the wireless communication system in the present embodiment, when uplink communication of a terminal is performed, a method of giving transmission grant from a base station to a terminal each time transmission is performed (dynamic grant) and a method of giving pre-grant of transmission from a base station to a terminal (configured grant) are specified (for example, NPL 1). In the pre-grant of transmission, time and frequency resources (hereinafter referred to as radio resources or resources) which can be used by the terminal in the uplink transmission are designated. In this designation, a period in which transmission can be performed using the resources is also designated.

In a method of granting pre-grant of transmission from a base station to a terminal, in known art, in order to avoid channel contention and data collision, allocating exclusive radio resources among a plurality of terminals can be considered. However, in the case of allocating exclusive radio resources among terminals, resource utilization efficiency decreases.

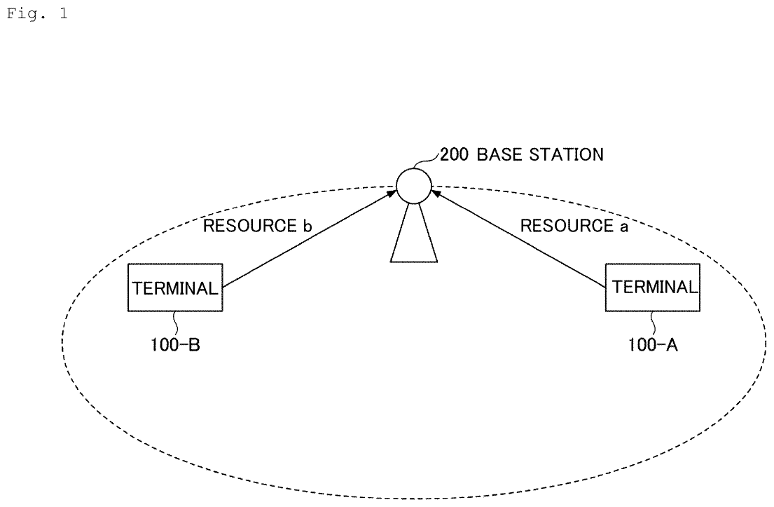

This will be described with reference to FIG. 1. FIG. 1 shows a base station 200, and a terminal 100-A and a terminal 100-B located within a communication area (cell) of the base station 200. In the example shown in FIG. 1, resources a and b are assumed to be respectively allocated from the base station 200 to the terminals 100-A and 100-B on the basis of pre-grant of transmission. The resources a and b are exclusive. Also, the term “exclusive” here means that the terminal 100-A performs transmission using the resource a at all transmission opportunities and thus if the terminal 100-B performs transmission using the resource b at all transmission opportunities, no collision occurs. The term “exclusive” may be synonymous with the term “non-overlapping.”

In this case, the terminal 100-A performs transmission using the resource a at a certain timing in an allocated period. However, the resource a is not used in a time period other than the time of transmission. Similarly, the terminal 100-B performs transmission using the resource b at a certain timing in an allocated period. However, the resource b is not used in a time period other than the time of transmission. That is, in known art, even in a case in which a resource allocated to a terminal on the basis of pre-grant of transmission is not used by the terminal, the resource cannot be used by another terminal, and thus the resource utilization efficiency decreases.

### Content of Processing of First Embodiment

In the first embodiment, in order to solve the above problems, the base station 200 pre-grants transmission of uplink communication using a non-exclusive radio resource to the plurality of terminals 100. Utilization of the non-exclusive radio resource is granted beforehand, and thus when each terminal 100 freely performs transmission in accordance with the grant, collision of transmission data or the like may occur. Thus, in the present embodiment, the terminals 100 perform LBT to implement transmission. An LBT method is not limited to a particular method, but for example, an LBT method of a near frequency band of NR-U defined for an unlicensed band by the 3GPP can be applied.

With respect to execution of LBT, in the first embodiment, there are patterns 1 to 3 below. The base station 200 may notify the terminals 100 of which pattern among patterns 1 to 3 is to be implemented, or it may be determined in advance for each base station 200 (cell).

### Pattern 1:

In pattern 1, the terminals 100 for which the pre-grant of transmission is set perform LBT and then implement the transmission at the time of the pre-granted transmission of uplink communication.

### Pattern 2:

In pattern 2, in a case in which the terminals 100 for which the pre-grant of transmission is set have the capability to execute LBT (terminal capability), they perform LBT and then implement the transmission at the time of the pre-granted transmission of uplink communication. Terminals not having the terminal capability implement the transmission without performing LBT at the time of the pre-granted transmission of uplink communication.

### Pattern 3:

In pattern 3, only in a case in which designation to perform the transmission using the method of pattern 1 is made in accordance with instructions from a network (NW) side (specifically, the base station 200) to the terminals 100, the terminals 100 for which the pre-grant of transmission is set perform LBT and then implement the transmission at the time of the pre-granted transmission of uplink communication. Signals used for the instructions from the base station 200 to the terminals 100 may be DCI, MAC CE, or RRC messages.

### Operation Example of First Embodiment

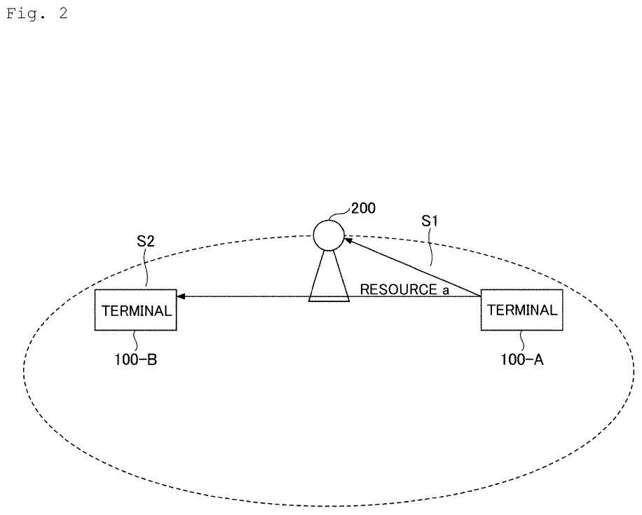

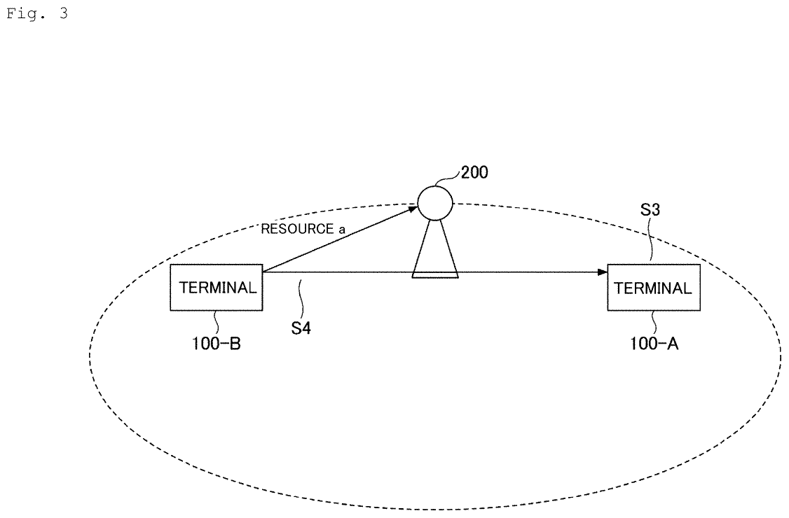

An operation example will be described with reference to FIGS. 2 and 3. Pattern 1 is assumed here. Alternatively, any terminal 100 may be assumed to have the capability of LBT in pattern 2. Alternatively, the base station 200 may be assumed to instruct each terminal 100 to execute the operation of pattern 1 in pattern 3.

In both of FIGS. 2 and 3, it is assumed that the pre-grant of transmission (configured grant) that has allocated the same radio resource (assumed as the resource a) to the terminal 100-A and the terminal 100-B is set. It is also assumed that transmission periods in the pre-grant of transmission are the same for the terminal 100-A and the terminal 100-B.

As shown in FIG. 2, in S1, the terminal 100-A performs transmission using the resource a. In this situation, in S2, the terminal 100-B attempts to perform transmission using the resource a, but in order to detect whether or not the resource a is in use using LBT, it waits without performing transmission.

As shown in FIG. 3, in S3, the terminal 100-A has completed transmission of data in a transmission queue and is in a data waiting state. In S4, the terminal 100-B performs LBT to detect that the resource a is in an idle state, and then performs transmission using the resource a.

### Effects of First Embodiment

In the first embodiment, the base station 200 pre-grants the transmission of uplink communication using the non-exclusive radio resource to the plurality of terminals 100, and thus the radio resource utilization efficiency in the area of the base station 200 can be improved, and the uplink transmission capacity can be increased.

In addition, in pattern 1, each terminal 100 executes LBT at the time of the pre-granted transmission of uplink communication, and thus other settings and messaging (signaling) are not required. Also, in pattern 1, it is assumed that all the terminals 100 have the capability to execute the operation of pattern 1.

In pattern 2, only the terminals 100 having the terminal capability for the operation of pattern 1 are assumed to perform transmission using the method of pattern 1, and thus, even in a case in which the terminals 100 having no LBT function and the terminals 100 having an LBT function coexist in the area, the operation according to the present embodiment can be realized without messaging (signaling) for distinguishing them.

In pattern 3, the transmission is assumed to be performed by the method of pattern 1 only in the case in which the designation is made in accordance with the instructions from the NW side to the terminals 100, and thus the NW can flexibly instruct each terminal 100 on execution of the operation according to the present embodiment or depending on a terminal environment.

Examples of a specific configuration and an operation of the first embodiment will be described below.

### <Configuration and Example of System>

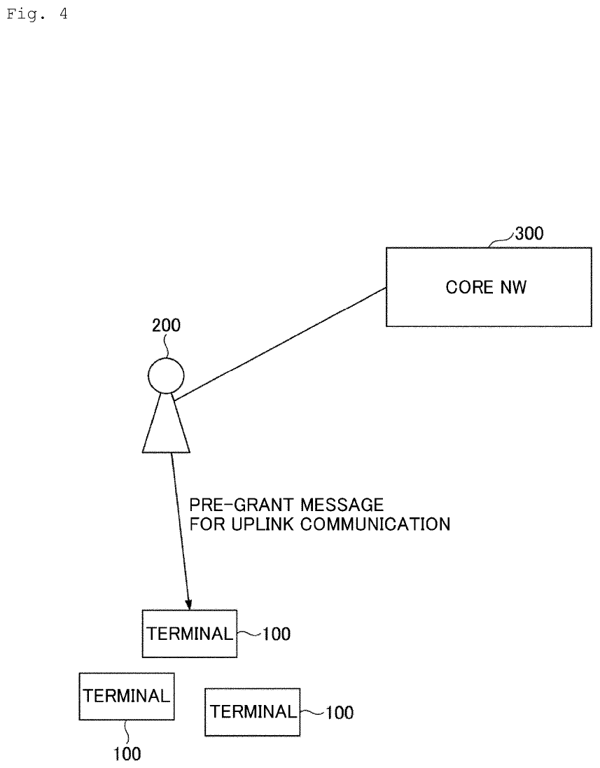

FIG. 4 shows an example of an overall configuration of a wireless communication system according to the first embodiment. The overall configuration of the wireless communication system is similar to a configuration of NR or the like and has a core NW 300, a base station 200, and a plurality of terminals 100. The core NW 300 is provided with a transfer device, a control device, and the like.

As shown in FIG. 4, the base station 200 designates transmission grant resource beforehand to the terminals 100 using a pre-grant message (for example, ConfiguredGrantConfig) for uplink communication. Type 1 and Type 2 are available for transmission methods based on the pre-grant of transmission.

In Type 1, the terminals 100 perform transmission using a pre-granted resource with an RRC grant message. In Type 2, the terminals 100 receive Enable or Disable (usable or unusable) from the base station 200 in DCI for a pre-granted resource with an RRC grant message. The terminals 100 perform transmission using the resource for which Enable is instructed in DCI.

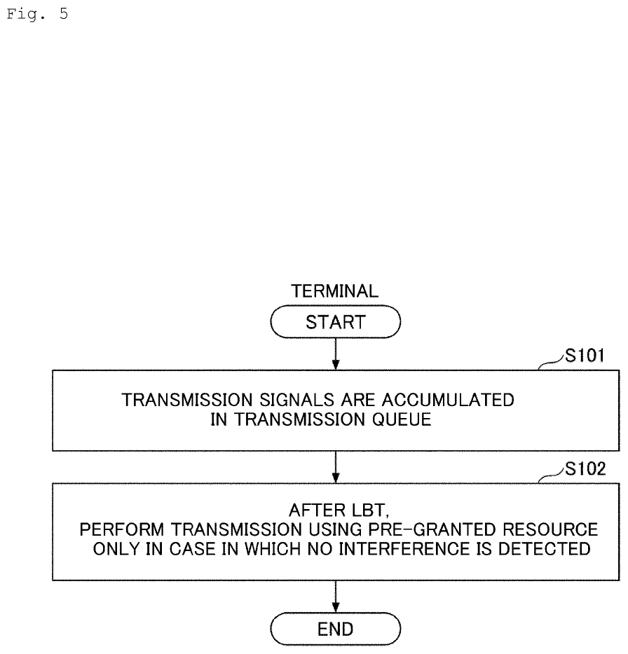

An operation example of the terminals 100 according to the first embodiment will be described with reference to the flowchart of FIG. 5. As a premise of the flowchart of FIG. 5, it is assumed that a transmission grant resource has already been notified from the base station 200 to the terminals 100 beforehand.

In S101, transmission signals (which may also be called transmission data) are accumulated in the transmission queue of the terminals 100.

In S102, the terminals 100 execute LBT with the accumulation of transmission signals in the transmission queue as a trigger, and as a result of the LBT, perform transmission using a pre-granted resource only in a case in which no interference from other terminals (or the base station 200) is detected.

### Second Embodiment

Next, the second embodiment will be described. In the second embodiment, for inter-terminal communication (which may be called a sidelink, D2D, or the like) in a wireless communication system operated in a license band, a base station permits a plurality of terminals to use a non-exclusive radio resource, thereby improving resource utilization efficiency. Since the terminals are granted use of the non-exclusive radio resource, the terminals execute an LBT operation at the time of transmission of the inter-terminal communication. The content of the second embodiment will be described in more detail below.

### Problems

In 5G New Radio (NR), which is a wireless communication system assumed in the present embodiment, inter-terminal communication is specified. In NR inter-terminal communication, there are Mode 1 in which transmission resources (of PSSCH and PSCCH) are allocated on the basis of transmission grant from a base station 200 to terminals 100, and Mode 2 in which the terminals 100 autonomously determine the transmission resources.

In the second embodiment, Mode 1 is assumed. In the Mode 1, a method of giving transmission grant from a NW side (the base station) to each terminal each time transmission is performed (dynamic grant) and a method of giving transmission grant beforehand (configured grant) are specified. The second embodiment is applicable to both dynamic grant and configured grant.

In a method of giving transmission grant from a base station to terminals in inter-terminal communication, it is conceivable to allocate exclusive radio resources among a plurality of transmission terminals in order to avoid signal collision or the like, but when the terminals are caused to execute transmission using exclusive radio resources, resource utilization efficiency decreases. On the other hand, when the terminals are caused to execute transmission using a non-exclusive radio resource (a radio resource that allows overlapping), collision between signals occurs and communication quality deteriorates.

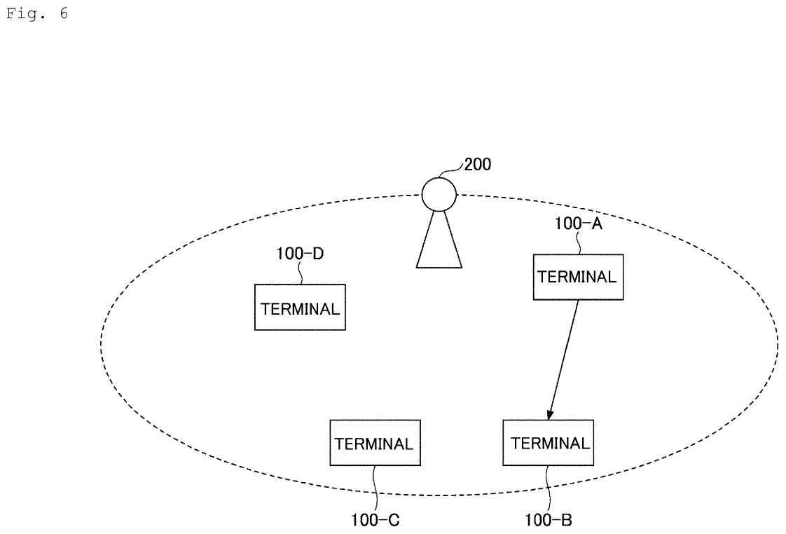

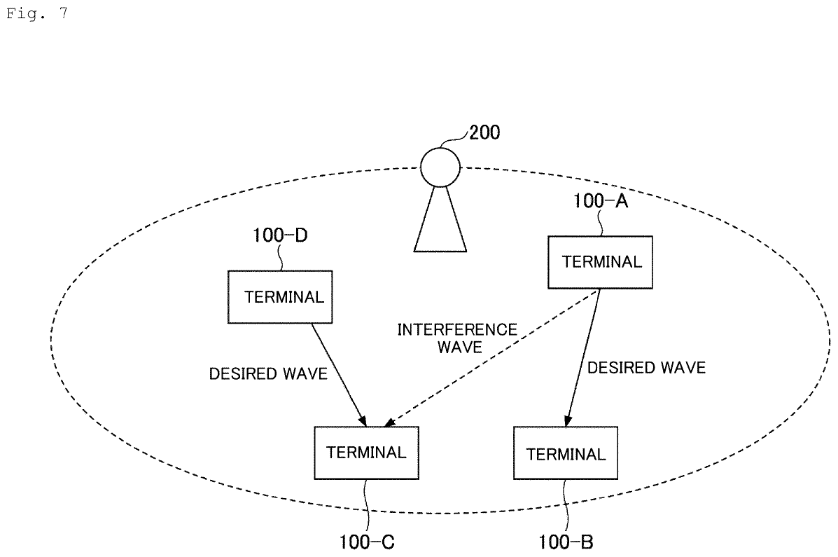

The above problems will be explained with reference to FIGS. 6 and 7. FIGS. 6 and 7 show the base station 200 and terminals 100-A, 100-B, 100-C and 100-D existing in a communication area (cell) of the base station 200.

First, a problem of reduction in radio resource utilization efficiency will be described with reference to FIG. 6. In FIG. 6, exclusive resources are allocated to each terminal 100 from the base station 200 as transmission resources for inter-terminal communication. In this case, for example, in a case in which the terminal 100-A performs transmission using an allocated resource, other terminals 100 do not perform transmission using the same resource at that time.

For example, in a case in which the terminal 100-D will not interfere with other terminals 100 even if it performs transmission using the same resource as the terminal 100-A, (when a distance between the terminals is large), the terminal 100-D does not perform transmission. Accordingly, in the case of FIG. 6, the radio resource utilization efficiency decreases.

Next, a case in which radio wave interference occurs due to signal collision will be described with reference to FIG. 7. In the example shown in FIG. 7, the same resource is allocated to the terminals 100-A and 100-D. In this case, when the terminal 100-A performs transmission using the resource, the terminal 100-D also performs transmission using the same resource.

A signal transmitted from the terminal 100-A to the terminal 100-B using the resource is a desired wave and is received by the terminal 100-B. A signal transmitted from the terminal 100-D to the terminal 100-C using the resource is a desired wave and is received by the terminal 100-C. However, since the signal from the terminal 100-A to the terminal 100-C interferes, the communication quality of the terminal 100-C deteriorates.

### Content of Processing of Second Embodiment

In the second embodiment, in order to solve the above problems, the base station 200 grants transmission of inter-terminal communication using a non-exclusive radio resource (a radio resource that allows overlapping) to a plurality of terminals 100 to transmit inter-terminal communication by Utilization of the non-exclusive radio resource is granted, and thus when each terminal 100 freely performs transmission in accordance with the grant, collision of transmission data or the like can occur. Thus, in the present embodiment, the terminals 100 perform LBT and then implement the transmission. Although an LBT method is not limited to a particular method, for example, an LBT method of a near frequency band of NR-U defined for an unlicensed band in 3GPP can be applied.

With respect to the execution of LBT, in the second embodiment, there are patterns 1 to 4 below. The base station 200 may notify the terminals 100 of which pattern among patterns 1 to 4 is to be implemented, or it may be determined in advance for each base station 200 (cell).

### Pattern 1:

In pattern 1, the terminals 100 granted to the transmission of inter-terminal communication perform LBT and then implement the transmission at the time of transmission using the granted resource. In pattern 1, the transmission is implemented after performing LBT in both of a case in which the grant (resource allocation) is performed for each transmission (dynamic grant) and a case in which the transmission is performed on the basis of pre-grant of transmission (configured grant).

### Pattern 2:

In pattern 2, the terminals 100 perform LBT and then implement the transmission in the case of performing the transmission on the basis of the pre-grant of transmission. The terminals 100 may perform the transmission without performing LBT in the case of performing the transmission on the basis of transmission grant (dynamic grant) each time the transmission is performed.

### Pattern 3:

In pattern 3, the terminals 100 perform the LBT of pattern 1 or pattern 2 and then implement the transmission in a case in which they have the capability to perform LBT (terminal capability). Terminals not having the terminal capability implement the transmission without performing LBT.

### Pattern 4:

In pattern 4, only in a case in which designation to perform the transmission using the method of pattern 1 or pattern 2 from the NW (network) side (specifically, the base station 200) to the terminals 100 is made, the terminals 100 perform the transmission using the designated method (pattern 1 or pattern 2).

Signals used for instructions from the base station 200 to the terminals 100 may be DCI, MAC CE, or RRC messages.

### Example of Operation of Second Embodiment

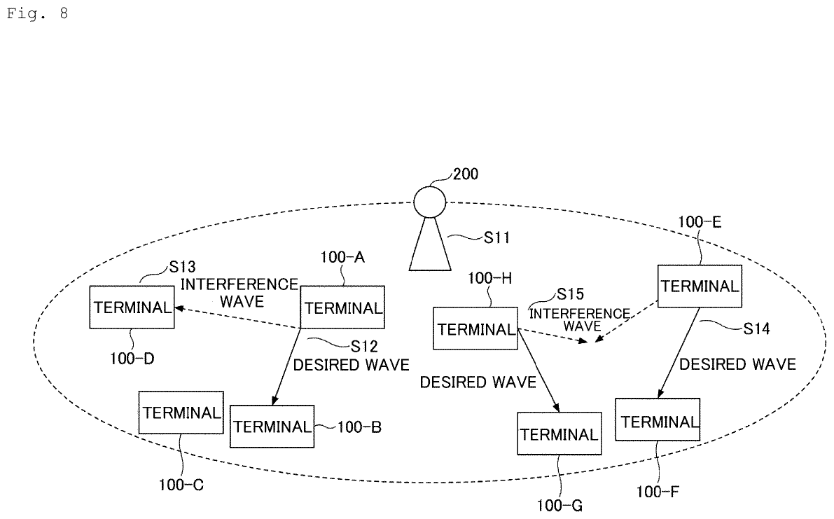

An operation example will be described with reference to FIG. 8. Pattern 1 is assumed here. Alternatively, pre-grant of transmission may be assumed to be given in pattern 2. Alternatively, any terminal 100 may be assumed to have the capability of LBT in pattern 3. Alternatively, the base station 200 may be assumed to instruct each terminal 100 to execute the operation of pattern 1 (or pattern 2) in pattern 4.

In S11, the base station 200 grants (or pre-grants) transmission using the same radio resource to each of the terminals 100-A and 100-D. Also, the base station 200 grants (or pre-grants) transmission using the same radio resource to each of the terminals 100-E and 100-H.

The same resource allocated to the terminal 100-A and the terminal 100-D is referred to as a “resource X,” and the same resource allocated to the terminal 100-E and the terminal 100-H is referred to as a “resource Y.”

In S12, the terminal 100-A is performing the transmission using the resource X, a desired wave reaches the terminal 100-B, and an interference wave reaches the terminal 100-D. In S13, transmission data is generated (data is accumulated in a transmission queue), and thus in order to perform transmission using the resource X, the terminal 100-D confirms by sensing whether or not other terminals are performing the transmission using the resource X. That is, LBT is performed.

Since the terminal 100-D detects that the interference wave of the resource X has arrived, the terminal 100-D waits for the transmission and avoids radio wave interference at a reception terminal (the terminal 100-B).

In S14, the terminal 100-E is performing transmission using the resource Y, and a desired wave reaches a terminal 100-F, but an interference wave does not reach the remote terminal 100-H. In S15, transmission data is generated (data is accumulated in a transmission queue), and thus in order to perform transmission using the resource Y, the terminal 100-H confirms by sensing whether or not other terminals are performing the transmission using the resource Y. That is, LBT is performed.

Since the terminal 100-H does not detect that the interference wave of the resource Y has arrived, the terminal 100-H performs the transmission using the resource Y. This enables efficient resource utilization. Also, depending on the LBT method, in a case in which the terminal 100-H does not detect that the interference wave of the resource Y has arrived, it may perform the transmission after waiting for a predetermined time.

### Effects of Second Embodiment

In the second embodiment, the base station 200 grants the transmission in inter-terminal communication using the non-exclusive radio resource to the plurality of terminals 100, and thus the radio resource utilization efficiency in the area of the base station 200 can be improved, and the transmission capacity can be increased.

Also, in pattern 1, each terminal 100 is caused to execute LBT at the time of the transmission in the granted inter-terminal communication, and thus other settings and messaging (signaling) are not required.

In pattern 2, the terminals 100 pre-granted of the transmission execute LBT at the time of performing the transmission in the inter-terminal communication, and thus, by exclusive transmission or an explicit instruction when individual transmission is granted by dynamic grant, LBT is not required, and simultaneous transmission with other terminals is possible. The collision is autonomously avoided only at the time of the pre-grant, thereby enabling flexible resource utilization.

In pattern 3, only the terminals 100 having the terminal capability of the operation of pattern 1 or pattern 2 perform the transmission using the method of pattern 1 or pattern 2, and thus even in a case in which the terminals 100 having no LBT function and the terminals 100 having the LBT function coexist in the area, the operations according to the present embodiment can be realized without messaging (signaling) distinguishing them.

In pattern 4, the transmission is performed using the method of pattern 1 or pattern 2 only in the case in which the designation is made by the instructions from the NW side to the terminals 100, and thus the NW can flexibly instruct each terminal 100 on execution of the operations according to the present embodiment or depending on a terminal environment.

Examples of a specific configuration and an operation of the second embodiment will be described below.

### <Configuration and Example of System>

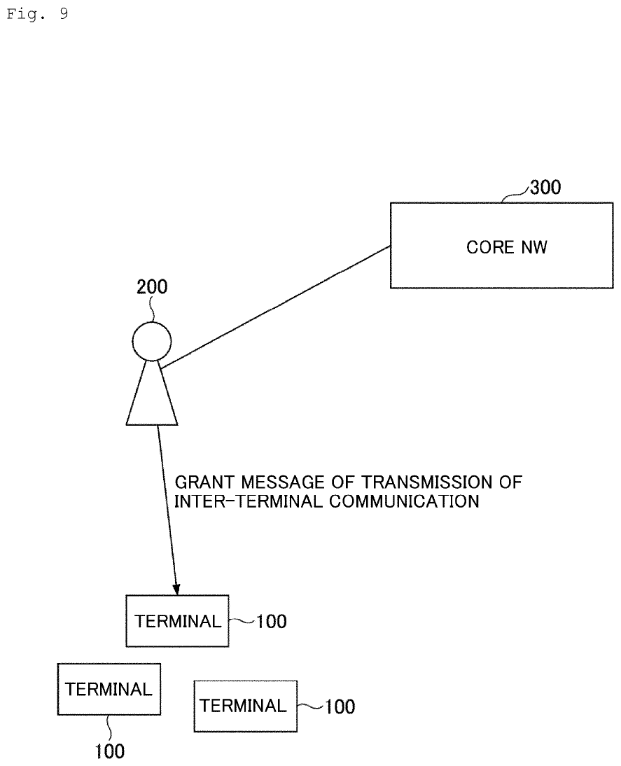

FIG. 9 shows an example of an overall configuration of a wireless communication system according to the second embodiment. The overall configuration of the wireless communication system is similar to a configuration of NR or the like, as in the first embodiment, and has a core NW 300, a base station 200, And a plurality of terminals 100. The core NW 300 is provided with a transfer device, a control device, and the like.

As shown in FIG. 9, transmission grant resources for inter-terminal communication are designated by grant messages for transmission in the inter-terminal communication from the base station 200 to the terminals 100. There are a case in which transmission grant (allocation of transmission resources) by the grant messages is performed each time the terminals 100 perform transmission (dynamic grant) and a case in which the transmission grant resources are designated beforehand (configured grant). For example, the dynamic grant is notified in DCI, and the configured grant is notified in RRC.

### Operation Example 1

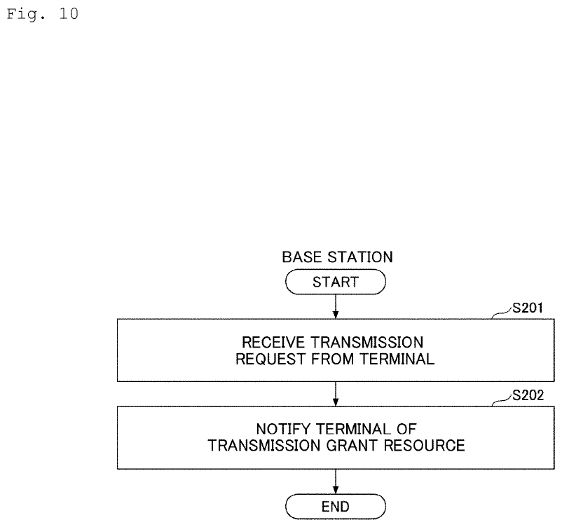

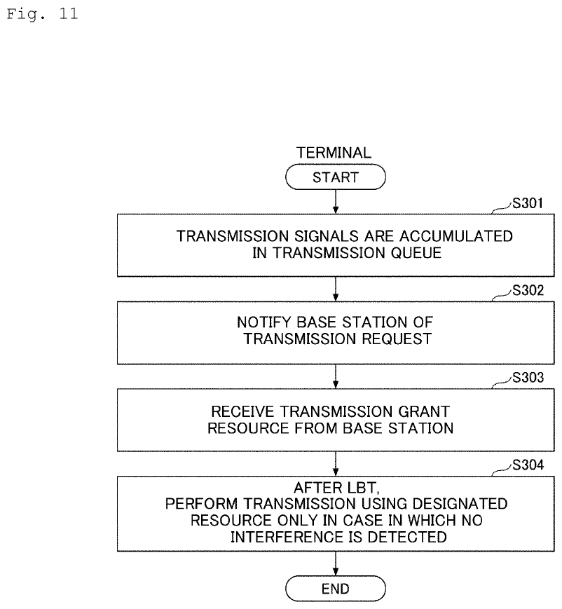

Operation examples of the base station 200 and the terminal 100 in the case of performing the transmission grant each time the transmission is performed will be described with reference to the flowcharts of FIGS. 10 and 11.

An operation example of the base station 200 will be described with reference to FIG. 10. In Step S201, the base station 200 receives a transmission request from the terminal 100. In S202, the base station 200 notifies the terminal 100 of a transmission grant resource.

An operation example of the terminal 100 will be described with reference to FIG. 11. In S301, transmission signals are accumulated in a transmission queue of the terminal 100. In Step S302, the terminal 100 transmits a transmission request to the base station 200.

In S303, the terminal 100 receives a transmission grant resource from the base station 200. In S304, the terminal 100 executes transmission using the designated resource only in a case in which no interference is detected after the LBT.

### Operation Example 2

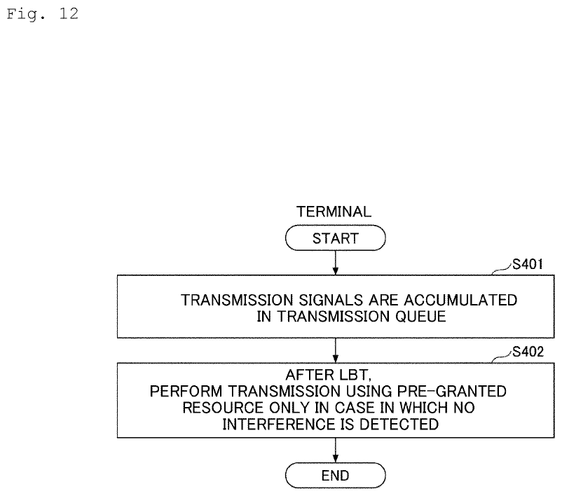

Next, operation examples of the base station 200 and the terminal 100 in the case of performing the pre-grant of transmission will be described with reference to the flowchart of FIG. 12.

As a premise of the flowchart of FIG. 12, it is assumed that a transmission grant resource for inter-terminal communication has already been notified from the base station 200 to the terminal 100 beforehand.

In S401, transmission signals (which may be called transmission data) are accumulated in a transmission queue of the terminal 100.

In S402, the terminal 100 executes LBT with the accumulation of transmission signals in the transmission queue as a trigger, and as a result of the LBT, only in a case in which no interference from other terminals is detected, transmission is performed using a pre-granted resource.

### (Configuration Example of Device)

A configuration example of a device common to the first embodiment and the second embodiment will be described below.

### <Terminal 100>

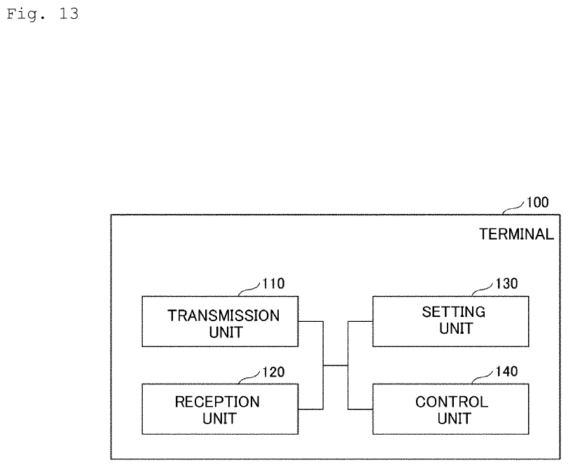

FIG. 13 is a diagram showing an example of a functional configuration of the terminal 100. As shown in FIG. 13, the terminal 100 has a transmission unit 110, a reception unit 120, a setting unit 130, and a control unit 140. The functional configuration shown in FIG. 13 is merely an example. Any names of functional units and distinguishment of functions may be used as long as the operations according to the embodiments of the present invention can be executed.

The transmission unit 110 creates a transmission signal from transmission data and wirelessly transmits the transmission signal. The reception unit 120 wirelessly receives various signals and acquires higher layer signals from the received physical layer signals. The reception unit 120 can perform an LBT operation.

For example, the transmission unit 110 may transmit, as D2D communication, physical sidelink control channel (PSCCH), physical sidelink shared channel (PSSCH), physical sidelink discovery channel (PSDCH), physical sidelink broadcast channel (PSBCH), or the like to another terminal 100, and the reception unit 120 may receive PSCCH, PSSCH, PSDCH, PSBCH, or the like from another terminal 100.

The setting unit 130 stores various setting information received from the base station 200 or another terminal 100 by the reception unit 120 in a storage device provided in the setting unit 130 and reads the setting information from the storage device as necessary. In addition, the setting unit 130 also stores preset setting information.

The control unit 140 controls the terminal 100. The control unit 240 includes a function of determining a frequency range to be used. A function unit related to signal transmission in the control unit 140 may be included in the transmission unit 110, and a function unit related to signal reception in the control unit 140 may be included in the reception unit 120. Also, the transmission unit 110 may be called a transmitter and the reception unit 120 may be called a receiver. In addition, the control unit 140 may be called a processor.

### <Base Station 200>

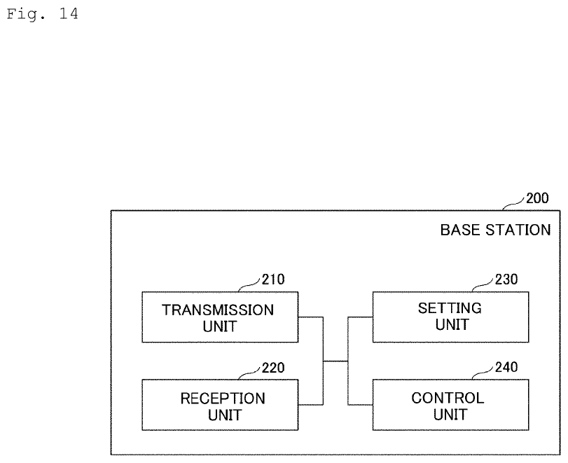

FIG. 14 is a diagram showing an example of a functional configuration of the base station 200. As shown in FIG. 14, the base station 200 has a transmission unit 210, a reception unit 220, a setting unit 230, and a control unit 240. The functional configuration shown in FIG. 14 is merely an example. Any names of functional units and distinguishment of functions may be used as long as the operation according to the embodiment of the present invention can be executed.

The transmission unit 210 includes a function of generating a signal to be transmitted to the terminal 100 side and transmitting the signal wirelessly. The reception unit 220 includes a function of receiving various signals transmitted from the terminal 100 and acquiring, for example, higher layer information from the received signals.

The setting unit 230 stores preset setting information and various setting information to be transmitted to the terminal 100 in a storage device provided in the setting unit 230 and reads out the setting information from the storage device as necessary.

The control unit 240 performs scheduling of DL reception or UL transmission of the terminal 20 via the transmission unit 210. A function unit related to signal transmission in the control unit 240 may be included in the transmission unit 210, and a function unit related to signal reception in the control unit 240 may be included in the reception unit 220. Also, the transmission unit 210 may be called a transmitter and the reception unit 220 may be called a receiver. In addition, the control unit 240 may be called a processor.

### <Example of Hardware Configuration>

Both the terminal 100 and the base station 200 (generically referred to as devices) can be realized, for example, by causing a computer to execute a program. This computer may be a physical computer or a virtual machine on the cloud.

That is, the device can be realized by executing a program corresponding to processing performed by the device using hardware resources such as a CPU and a memory built into a computer. The program can be stored and distributed by being recorded in a computer-readable recording medium (portable memory or the like). In addition, the above program can also be provided through a network such as the Internet or e-mail.

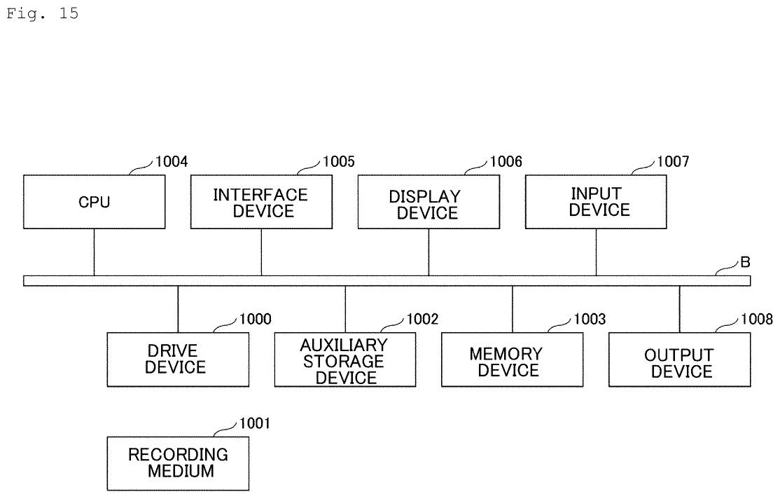

FIG. 15 is a diagram showing an example of a hardware configuration of the computer. The computer of FIG. 15 has a drive device 1000, an auxiliary storage device 1002, a memory device 1003, a CPU 1004, an interface device 1005, a display device 1006, an input device 1007, and an output device 1008, which are connected to each other by a bus BS.

The program implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 through the drive device 1000. However, the program does not necessarily need to be installed from the recording medium 1001 and may be downloaded from another computer via the network. The auxiliary storage device 1002 stores the installed program and also stores necessary files, data, and the like.

The memory device 1003 reads and stores the program from the auxiliary storage device 1002 when an instruction to start the program is given. The CPU 1004 implements a function relevant to the device in accordance with the program stored in the memory device 1003. The interface device 1005 is used as a communicator for connection to the network. The display device 1006 displays a graphical user interface (GUI) and the like according to the program. The input device 1007 is configured of a keyboard, a mouse, buttons, a touch panel, or the like and is used for inputting various operation instructions. The output device 1008 outputs calculation results.

### APPENDIX

The present specification discloses at least a wireless communication system, a terminal, and a communication method according to the following items.

### (Item 1)

A wireless communication system provided with a base station and a plurality of terminals and operated by a licensed band, wherein
the base station allocates, to the plurality of terminals, a radio resource for transmission that allows overlapping between the plurality of terminals, and
all or some of the plurality of terminals execute listen before talk (LBT) and then perform transmission using the allocated radio resource.

### (Item 2)

The wireless communication system according to item 1, wherein,
among the plurality of terminals, a terminal having an LBT function executes LBT and then performs the transmission using the allocated radio resource, and a terminal not having the LBT function performs the transmission using the allocated radio resource without executing the LBT.

### (Item 3)

A terminal in a wireless communication system provided with a base station and a plurality of terminals and operated by a licensed band, comprising:
a reception unit configured to receive, from the base station, a message that allocates a radio resource for transmission that allows overlapping of a radio resource allocated to other terminals; and
a transmission unit configured to perform transmission using the allocated radio resource after execution of listen before talk (LBT) by the reception unit.

### (Item 4)

The terminal according to item 3, wherein,
in a case in which the reception unit receives an instruction to perform the transmission after the execution of LBT from the base station, the transmission unit performs the transmission after the execution of LBT.

### (Item 5)

The terminal according to item 3 or 4, wherein
the transmission unit performs transmission in uplink communication or transmission in inter-terminal communication.

### (Item 6)

A communication method in a wireless communication system provided with a base station and a plurality of terminals and operated by a licensed band, wherein
the base station allocates, to the plurality of terminals, a radio resource for transmission that allows overlapping between the plurality of terminals, and
all or some of the plurality of terminals execute listen before talk (LBT) and then perform transmission using the allocated radio resource.

Although the present embodiment has been described above, the present invention is not limited to the specific embodiment, and various modifications and changes can be made within the scope of the gist of the present invention described in the claims.

### REFERENCE SIGNS LIST

100 Terminal
110 Transmission unit
120 Reception unit
130 Setting unit
140 Control unit
200 Base station
210 Transmission unit
220 Reception unit
230 Setting unit
240 Control unit
300 Core NW
1000 Drive device
1001 Recording medium
1002 Auxiliary storage device
1003 Memory device
1004 CPU
1005 Interface device
1006 Display device
1007 Input device
1008 Output device

1. A wireless communication system provided with a base station and a plurality of terminals and operated by a licensed band, wherein
the base station includes:
a first processor; and
a first memory that includes instructions, which when executed, cause the first processor to:
allocate, to the plurality of terminals, a radio resource for transmission that allows overlapping between the plurality of terminals, and wherein
each of the plurality of terminals includes:
a second processor; and
a second memory that includes instructions, which when executed, cause the second processor in all or some of the plurality of terminals to:
execute listen before talk (LBT) and then perform transmission using the allocated radio resource.

2. The wireless communication system according to claim 1,
wherein,
among the plurality of terminals, the second processor in a terminal having an LBT function is caused to execute LBT and then perform the transmission using the allocated radio resource, and the second processor in a terminal not having the LBT function is caused to perform the transmission using the allocated radio resource without executing the LBT.

3. A terminal in a wireless communication system provided with a base station and a plurality of terminals and operated by a licensed band, the terminal comprising:
a processor; and
a memory that includes instructions, which when executed, cause the processor to:
receive, from the base station, a message that allocates a radio resource for transmission that allows overlapping of a radio resource allocated to other terminals; and
perform transmission using the allocated radio resource after execution of listen before talk (LBT) by the reception unit.

4. The terminal according to claim 3, wherein,
in a case of receiving an instruction to perform the transmission after the execution of LBT from the base station, the processor is caused to perform the transmission after the execution of LBT.

5. The terminal according to claim 3, wherein
the processor is caused to perform transmission in uplink communication or transmission in inter-terminal communication.

6. A communication method in a wireless communication system provided with a base station and a plurality of terminals and operated by a licensed band, wherein the base station allocates, to the plurality of terminals, a radio resource for transmission that allows overlapping between the plurality of terminals, and
all or some of the plurality of terminals execute listen before talk (LBT) and then perform transmission using the allocated radio resource.
